(19) United States
(12) Patent Application Publication
(10) Pub. No.: US 2024/0369906 A1
(43) Pub. Date: Nov. 7, 2024

(54) OPTICAL WAVEGUIDE COMPONENTS POSSESSING HIGH NONLINEAR EFFICIENCY AND ADAPTIVE-PROFILE POLING PROCESS TO FABRICATE THE SAME

(71) Applicant: ARIZONA BOARD OF REGENTS ON BEHALF OF THE UNIVERSITY OF ARIZONA, Tucson, AZ (US)

(72) Inventors: Linran FAN, Tucson, AZ (US); Pao-Kang CHEN, Tucson, AZ (US)

(21) Appl. No.: 18/778,281

(22) Filed: Jul. 19, 2024

Related U.S. Application Data
(63) Continuation of application No. PCT/US2023/011340, filed on Jan. 23, 2023.
(60) Provisional application No. 63/302,331, filed on Jan. 24, 2022.

(51) Int. Cl. G02F 1/355; G02F 1/377

(52) U.S. Cl. CPC G02F 1/3558; G02F 1/3775

(57) ABSTRACT

The adaptive methodology of (purposefully, intentionally aperiodically) poling of an optical waveguide made in a nonlinear material substrate to achieve a continuous increase of overall nonlinear conversion efficiency with increase in the length of such waveguide. As a result of such poling, the variation of at least a waveguide thickness is compensated by adjusting the poling period along the waveguide to match the local momentum difference of the nonlinear process. For a second-harmonic generation, a near-ideal performance of the nonlinear energy conversion process was demonstrated even for a 21 mm long waveguide (with the SHG efficiency as high as 9415%/W and a 82.6% absolute power conversion efficiency). The adaptive poling methodology can also be applied to compensate other systematic inhomogeneity of a WG device in, for example, etching depth, diffusion depth, dose of lithographic exposure of the nonlinear material, and doping density across the nonlinear material substrate.

### CROSS-REFERENCE TO RELATED APPLICATIONS

This US Patent Application is a continuation of the International Patent Application No. PCT/US2023/011340 filed on Jan. 23, 2023 and now published as WO 2024/054243, which in turn claims priority from and benefit of the U.S. Provisional Patent Application No. 63/302,331 filed on Jan. 24, 2022. The entire disclosure of each of the above-mentioned patent documents is incorporated by reference herein.

### STATEMENT REGARDING FEDERALLY SPONSORED RESEARCH OR DEVELOPMENT

This invention was made with government support under Grant Number N00014-19-1-2190 awarded by NAVY/ONR. The government has certain rights in the invention.

### TECHNICAL FIELD

The present invention relates to methodologies of increasing the efficiency (ies) of non-linear conversion of optical energy and, in particular, to systems and methods of increasing the efficiency of non-linear conversion of optical energy in optical waveguides fabricated in materials possessing optical non-linearity.

### RELATED ART

Nanophotonic lithium niobate waveguide devices (or simply waveguides, for short) are promising to realize high nonlinear efficiency devices as they provide confinement of optical field at nanoscale and possess strong material second-order nonlinearity. However, the non-uniformity (for example, inhomogeneity) of practically-implemented devices has restricted the demonstration of high normalized efficiency to rather short devices. small device length. As a result, the overall nonlinear efficiency achievable to-date remains quite low.

### SUMMARY OF THE INVENTION

The discussed research results convincingly show that the phase mismatch (between the initial—for example, fundamental-optical harmonic, IOH, and the target optical wave, TOW, into which such IOH is intended to be converted) caused by the thickness variation of thin-film non-linear crystal wafers (or substrates; in one case-thin-film version of lithium niobate wafers or substrates) is the major factor that limits the overall efficiency of the intended nonlinear conversion. According to the idea of the invention, the proposed adaptive poling approach is configured to compensate for such thickness variation. By matching the poling period to the local device thickness, substantially perfect phase matching can be realized over the entire device, thereby leading to the constructive build-up of the nonlinear process as the optical wave(s) propagate. For example, some experimental results demonstrated 9415+/−1177%/W second harmonic efficiency and 82.6% absolute power conversion efficiency with the near-ideal sinc²-function type distribution of the spectrum of the so-generated second-harmonic. The peak of nonlinear efficiency scaled quadratically with the length of the waveguide device length. The use of the proposed adaptive poling approach showed an 8.6-fold improvement over the results achievable with the conventionally-configured periodic poling (with a waveguide device of about 21 mm). The newly proposed poling approach paves the way for future large-scale photonic systems—in a specific example, those made with the use of non-linear crystalline materials.

Embodiments of the invention provide an optical component that includes a material substrate that has an axis and that is characterized by an axial profile of non-linearity (of a material of said substrate) that is not periodic. Here, the axial profile is formed by poled domains of the material, and different domains necessarily have different from one another axial geometric extents (that is, geometric extents as measures along the axis). In one case, the axial geometric extents of the different domains are dependent on inhomogeneous distribution of at least one material parameter and/or at least one geometric parameter of the material substrate along the axis, and/or the material of the substrate includes at least one of identified preferred materials (as defined below), and the different domains include a first ferroelectric domain that has a first axial geometrical extent along the axis, a second ferroelectric domain has a second geometrical extent along the axis, and a third ferroelectric domain has a third geometrical extent along the axis, and wherein each of the first, second, and third geometrical extents is different from the other two of the first, second, and third geometrical extents. Substantially in every implementation, the optical component may include an optical waveguide formed in or at the material substrate, the axis being the axis of such and the axial profile of non-linearity and the different domains being those of the waveguide. (In at least one specific case of the latter, the axial geometric extents of the different domains of the waveguide are dependent at least on corresponding different values of thickness of the waveguide at locations of the different domains; and/or the material of the waveguide includes at least one of identified preferred materials, and the different domains include a first ferroelectric domain that has a first axial geometrical extent along the axis, a second ferroelectric domain has a second geometrical extent along the axis, and a third ferroelectric domain has a third geometrical extent along the axis, and wherein each of the first, second, and third geometrical extents is different from the other two of the first, second, and third geometrical extents. In at least one related case of the latter, the material substrate includes a birefringent material and domains, which are spaced substantially irregularly along the axis, represent such birefringent material poled substantially aperiodically along the axis.) Substantially in every implementation, the axial extents of the different domains may be configured to substantially satisfy a quasi-phase matching condition for a predefined process of nonlinear conversion of optical energy substantially at every chosen point of said axis (and/or, when the waveguide is present in the optical component, to substantially satisfy a quasi-phase matching condition for such predefined process substantially at every chosen region of the waveguide. Generally, the predefined process of nonlinear conversion includes one of identified preferred nonlinear processes (as defined below). Embodiments of the invention additionally provide a photonic device (as identified below) that contains an implementation of the optical component identified above.

Embodiments of the invention additionally provide a method for fabricating substantially every embodiment of the optical component identified above. Such method includes a step of poling the material substrate that is characterized by an inhomogeneous axial distribution of at least one material and/or at least one geometric parameter of the substrate. The poling of the substrate is dimensioned to be aperiodic along the axis while an axial geometrical extent of a given poled region of the material substrate is necessarily dependent on a value of such at least one material and/or at least one geometric parameter of the material substrate at a location of such poled region along the axis. In one case, the poling step includes poling at least one of identified preferred materials (while the substrate made of such at least one of identified preferred material has an inhomogeneous axial distribution of at least one material and/or at least one geometric parameter of the substrate) such as to form the different domains (that include a first ferroelectric domain that has a first axial geometrical extent along the axis, a second ferroelectric domain has a second geometrical extent along the axis, and a third ferroelectric domain has a third geometrical extent along the axis such that each of the first, second, and third geometrical extents is different from the other two of the first, second, and third geometrical extents). Here, a corresponding axial geometrical extent of each of the different domains is defined to be necessarily dependent on a value of at least one material and/or geometric parameter of the substrate at a location of such domain along the axis. (In one specific case, when the substrate made of such identified preferred material(s) carries a waveguide or is configured to carry a waveguide, the step of poling includes poling such at least one of identified preferred materials to form the axial geometric extents of the different poled domains of the waveguide that are dependent at least on corresponding different from one another values of thickness of the waveguide at locations of the different poled domains. In particular, the step of poling may include a poling the material substrate along a length of the waveguide already formed therein such as to form the poled domains to include a first ferroelectric domain that has a first axial geometrical extent along the axis, a second ferroelectric domain has a second geometrical extent along the axis, and a third ferroelectric domain has a third geometrical extent along the axis, and where each of the first, second, and third geometrical extents is different from the other two of the first, second, and third geometrical extents.) Each of implementations of the method may additionally include a step of a non-uniformity of the material and/or geometrical parameter of the material substrate (and, when the substrate carried the waveguide—the non-uniformity of the material and/or geometrical parameter of the waveguide—in particular, a thickness of the waveguide) along the axis to define a distribution of a longitudinal extents of a target poled domain of the material substrate as a function of the axial length of the substrate (and/or the axial length of the waveguide, when present). In at least one specific case when the substrate is configured to carry the optical waveguide, the step of poling may include poling the material of the substrate such that the axial geometrical extent of the given poled region of the waveguide is dependent at least in part on a value of a width of the waveguide and/or a value of an index of refraction of the waveguide at a location of the given poled region (which step can be complemented with another step of determining a non-uniformity of the thickness of the waveguide along the axis and/or a non-uniformity of the width of the waveguide and/or a non-uniformity of the index of refraction of the waveguide along the length thereof to define a distribution of a longitudinal extent of a target inversion of a poled domains of the material substrate as a function of the length.) In at least one case, the method may include forming the waveguide in the substrate.

Embodiments of the invention further provide a method that includes compensating for decrease in an efficiency of a target process of nonlinear optical frequency conversion in an optical waveguide (where such deficiency is caused by non-uniformities of fabrication of the optical waveguide) to satisfy a quasi-phase-matching condition for the target process substantially at every region of the optical waveguide by poling a material of a substrate carrying the optical waveguide at least aperiodically along the axis such that an axial geometrical extent of a given poled region of the waveguide is necessarily dependent on at least one of a value of thickness of the waveguide, a value of a width of the waveguide, and a value of an effective index of refraction of the waveguide at a wavelength associated with the target process at a location of the given poled region. The target process preferably includes one of identified preferred nonlinear processes.

### BRIEF DESCRIPTION OF THE DRAWINGS

The idea and scope of the invention will be more fully understood by referring to the following Detailed Description of Specific Embodiments in conjunction with the Drawings, of which:

FIG. 1A: A schematic of a poled lithium niobate nanophotonic waveguide. Differently colored regions of poling represent opposite orientations of neighboring domains of lithium niobate (LN). FIG. 1B: A schematic of spatial distribution of a TE optical mode at 775 nm wavelength across the waveguide of FIG. 1A. FIG. 1C: A schematic of spatial distribution of a TE optical mode at 1550 nm wavelength across the same waveguide.

FIG. 2A: The schematic of the adaptive poling of a non-linear waveguide (WG) device. The poling periods depend on the local momentum mismatch at different locations along the length of the WG.

FIG. 2B: A vector-based illustration of the phase diagram of the SHG field generated in a conventionally periodically poled WG device of FIG. 1A. Variations of thickness of the WG device prevents the generated SHG field from being accumulated constructively.

FIG. 2C: A vector-based illustration of the phase diagram of the SHG field generated with the use of adaptive poling approach. Here, locally adjusted poling period compensates for the local variation of the WG thickness, thereby leading to a substantially maximized, perfect quasi-phase matching.

FIG. 2D presents a plot 220 showing the simulated variation of the poling period for achieving the ideal quasi-phase matching condition in a WG device possessing thickness variations, using Finite element simulation solutions. Insert: The distribution of the fundamental and second-harmonic fields at 1550 nm and 775 nm, respectively. Waveguide width 1.8 microns, etch depth about 350 microns.

FIG. 2E: Curve 230 shows the measured thickness of the lithium niobate device layers along the waveguide. Inset: a plot 240 of reflection spectrum measured for a 607.11 nm thick lithium niobate layer with the use of Filmetrics F40.

FIG. 2F presents the simulated second-harmonic spectrum upon propagation of the corresponding optical wave along the non-linear WG with periodic poling and assuming the thickness variation of such WG shown in FIG. 2E. Used theoretical limit of normalized efficiency is 2388%/W/cm².

FIG. 2G demonstrates development of the simulated peak values of the second-harmonic efficiencies determined along the length of the WG addressed in FIG. 2F, for the conventional periodic poling of such a WG (curve 250) and the proposed adaptive poling (curve 260). Used theoretical limit of normalized efficiency is 2388%/W/cm².

FIG. 3 illustrates the poling electrode schematic for X-cut and Z-cut lithium niobate wafers.

FIGS. 4A, 4B, 4C, and 4D: steps of fabrication of nanophotonic lithium niobate waveguide, configured according to the idea of the invention. FIG. 4A: Scanning electron microscopy (SEM) image of one fabricated waveguide. FIG. 4B: Lithium niobate domain inversion image produced through SEM image with buffered oxide etching. FIG. 4C piezoresponse force microscopy image with false color showing the waveguide. FIG. 4D SEM image of the fabricated device cross-section with false color showing poling (poled) domains.

FIGS. 5A, 5C, 5E, and 5G display measured and simulated second-harmonic spectra of the TFLN waveguides. FIGS. 5B, 5D, 5F, and 5H show corresponding measured thicknesses and designed poling periods. Here, FIGS. 5A, 5B represent the periodically poled 3 mm long device; FIGS. 5C, 5D represent the adaptively poled 3 mm long device; FIGS. 5E, 5F represent the periodically poled 21 mm long device; while FIGS. 5G, 5H represent the adaptively poled 21 mm long device.

FIG. 6A illustrates the peak value of SHG efficiency for different waveguide lengths with two poling approaches. Dash line: 2044%/W/cm². FIG. 6B addresses Inhomogeneity-caused SHG efficiency to decrease the ratio of different waveguide lengths with two poling approaches. Dash line: Rᵢₙₕₒₘₒ=1. FIG. 6C illustrates the absolute power conversion efficiency in a 21 mm waveguide that was poled adaptively.

FIG. 7A: Comparison of overall SHG efficiency achieved with discussed embodiments and with other state-of-art thin-layer LN/bulk-LN devices. FIG. 7B: Comparison of absolution conversion efficiency as a function of the pump power achieved with discussed embodiments and with other state-of-art thin layer LN/bulk-LN devices. Star: present embodiments. Circle: thin layer Lithium Niobate. Cross: Bulk LN. Diamond: thin layer LN microring resonators.

FIG. 8 illustrates a dependency of a phase-mismatch parameter formed in a lithium niobate as a function of a wavelength of a fundamental harmonic of a SHG process in such a waveguide.

Generally, like elements or components in different Drawings may be referenced by like numerals or labels and/or the sizes and relative scales of elements in Drawings may be set to be different from actual ones to appropriately facilitate simplicity, clarity, and understanding of the Drawings. For the same reason, not all elements present in one Drawing may necessarily be shown in another.

### DETAILED DESCRIPTION

This disclosure explores the optical momentum mismatch, caused by various non-uniformities of material and/or geometrical parameter(s) of a chosen material substrate (and, in particular—by the thickness variation of the optical crystalline material wafers carrying optical waveguides; presented here, without any limitation, by discussing the specific case of thin-film lithium niobate wafers), to be the major factor limiting the overall nonlinear efficiency. According to the idea of the invention, the problem of limitation of the overall nonlinear efficiency caused by such inhomogeneities (in particular-thickness variation) is solved by poling the subject material substrate (and, in the specific case when such substrate carries an optical waveguide—by poling the subject waveguide) aperiodically such as to defined an adaptive spatial profile of nonlinearity (interchangeably referred to herein as the adaptive poling profile or aperiodic poling profile or adaptively defined poling profile) to compensate at least for the variation of thickness (of the waveguide) along the chosen axis (and, generally, for inhomogeneities of such waveguide) based and dependent on a spatial distribution of values of at least a predetermined geometrical characteristic of such waveguide. By judiciously matching the poling period to local device thickness, substantially ideal or target quasi-phase matching condition can be realized over the entire device, thereby leading to the constructive build-up of the nonlinear process along the whole length of the subject poled waveguide. Implementation oft least one implementation demonstrated the near-ideal sinc²-function for the spectrum of the second-harmonic generated in a waveguide device configured according to the idea of the invention.

The discussion of the idea of the invention is presented below on the example of a waveguide formed in a target nonlinear medium or, generally substrate (which term is used herein to define a solid substrate or medium) Various non-linear optical materials and, in particular, lithium niobate (LiNbO₃ or LN, for short) proved to be one of major driving forces for research and development in modern optics. The large second-order coefficient of LN has enabled efficient second-harmonic generation, parametric down-conversion, and sum-/difference-frequency generation, thus providing foundation for numerous optical applications in both classical and quantum regime (which applications include optical parametric oscillation, quantum state generation, quantum frequency conversion, and supercontinuum generation, to name just a few). To achieve high nonlinear efficiency of a LN-based device, the well-known in the art phase-matching condition must be fulfilled, according to which the total momentum is preserved during the nonlinear process. This condition is normally satisfied in practice by periodically inverting the orientations of ferroelectric domains of lithium niobate. As is well known in the art, the additional momentum provided by the so-formed periodic structure compensates the original momentum mismatch among different optical fields participating in a given nonlinear process. In practice, the poling period is judiciously defined to select the wavelength of operation for the second-order nonlinear process in lithium niobate, for example. Periodically poled lithium niobate (PPLN) is known as a domain-engineered lithium niobate crystal, used mainly for achieving quasi-phase-matching in nonlinear optics. The ferroelectric domains point alternatively to the +c and the −c direction, with a period of typically between 5 and 35 μm (while poling with a sub-micron period has also been demonstrated).

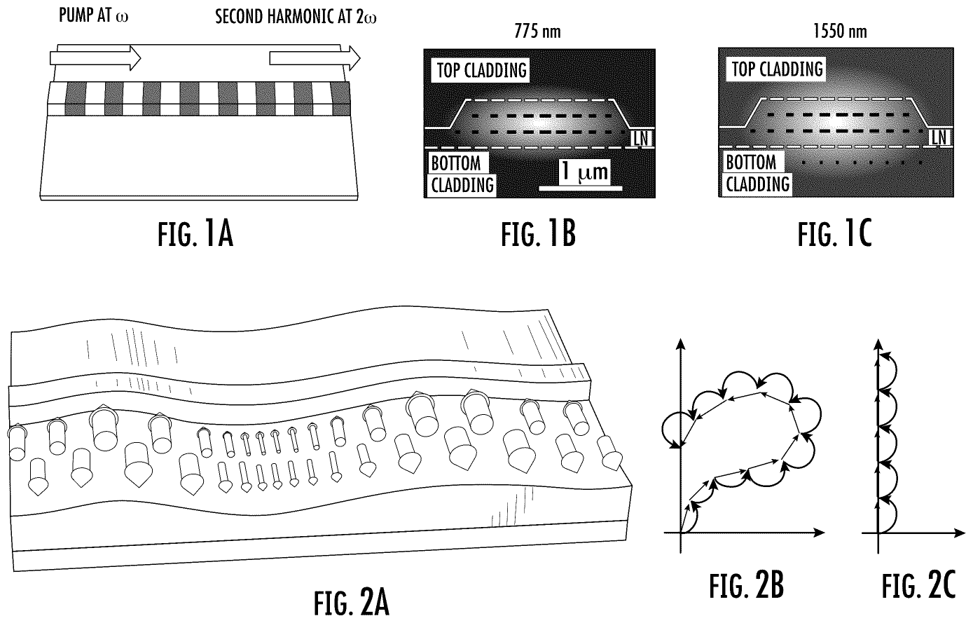

A skilled artisan knows that the spatial confinement of an optical mode in a nanoscale waveguide structure can enhance the strength of an optical field propagating through such structure, thereby leading to the improvement of the nonlinear efficiency characterizing this structure. (Such enhancement has been implemented with thin-film lithium niobate to demonstrate large-bandwidth low-Vₚ electro-optic modulation, high-efficiency microwave-to-optic transduction, strong single-photon nonlinearity, efficient second-harmonic generation, and parametric down-conversion. FIGS. 1A, 1B, and 1C schematically illustrate the distribution of optical fields of fundamental and second harmonics in a periodically poled waveguide device.) However, the overall frequency conversion efficiency is still not comparable to that demonstrated by its bulk counterparts. As a figure of merit of frequency conversion efficiency, the state-of-art overall second harmonic generation efficiency of a thin-film LN (also referred to in the art as integrated lithium niobate, TFLN) has been demonstrated at 939%/W with normalized efficiency as high as 3757%/W/cm². However, the overall efficiency is not even closer to the highest bulk LN efficiency of 2400%/W with normalized SHG efficiency of only 96%/W/cm².

Provided that optical field is tightly confined in a given device (such as a waveguide), small perturbation in the structure of such device can and do, understandably, cause significant change in the optical properties of such device. One should appreciate, therefore, the spatial uniformity of nanophotonic devices inevitably plays a substantially more important role in determining the performance of the overall waveguide-based device as compared with performance of a device employing a bulk of the same material.

Thin-film version of a non-linear crystalline material (in the considered case-lithium niobate) is manufactured with the used of the so-called smart-cut process. Uncertainties in achieving the target depth of ion implantation of the thin-film layer of LN and rate of chemical-mechanical polishing of such layer during the fabrication of a thin-film-based LN device cause variations of thickness of the layer of the resulting device, thereby leading to the variations of phase-matching condition along the length of the waveguide formed in such thin-film LN. This non-uniformity (inevitably complemented with various other geometry inhomogeneities die fabrication error(s)) substantially prevents the repeatable manufacture of high-performance nonlinear devices, as well as the large-scale photonic circuits based on thin-film lithium niobate.

As discussed below in detail with the use of a specific example of a second-order non-linear process, the problem of spatial non-uniformity of at least non-linear crystal material (in a specific discussed case—lithium niobate) and/or of a waveguide formed in such material is overcome by implementing the adaptive, non-periodic profile poling of such material and/or the waveguide formed in such material. It is to be understood that, in comparison with a conventional targeted periodic poling of material substrates configured to carry an optical waveguide during which the substantially spatially periodic poling profile is sought, the non-periodic (aperiodic) poling discussed herein is that in which the poling of the substrate is done aperiodically—that is according to a function that purposefully, by design does not repeat its values at a set period or periods. Aperiodicity as defined and used here goes beyond the typical experimental errors encountered during practical implementation of the periodic poling of the related art. Phrased differently, an axial distribution of a poling profile resulting from the periodic poling of a material (with or without errors made in such profile) do not qualify as an aperiodic poling profile formed according to the idea of the invention (which aperiodic profile is devised adaptively to depend on a local value of a material parameter and/or a geometrical parameter of the substrate/waveguide defined along the axis thereof.

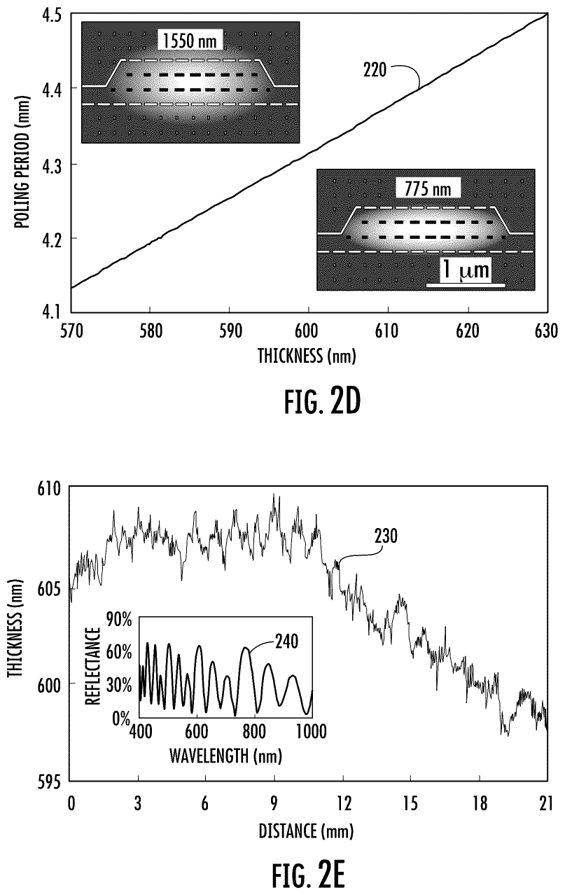

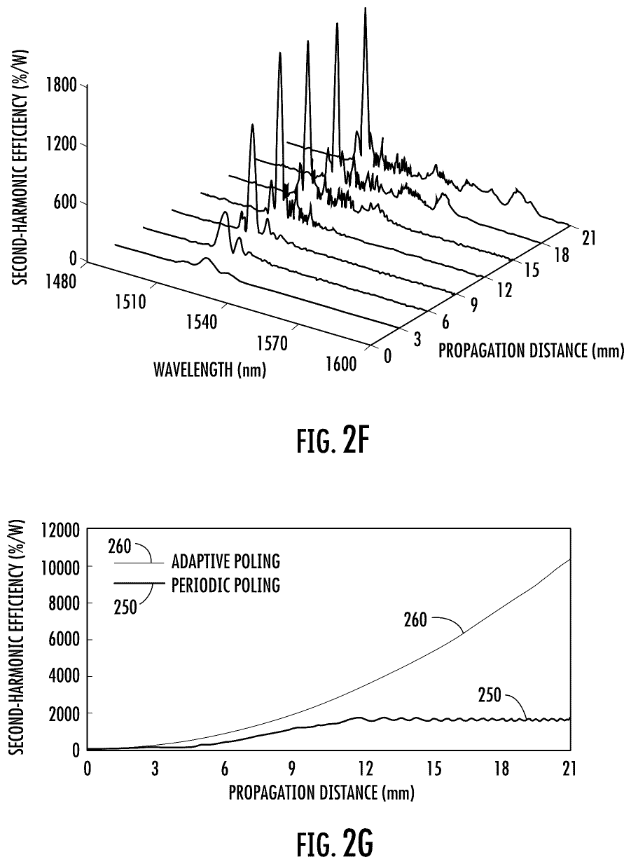

According to the idea of the invention, and in advantageous contradistinction to standard, conventional periodic poling—where the domain inversion period is fixed—in an embodiment of the invention the spatial extent of poled waveguide sections (which is the case of conventional poling procedure is referred to as poling period) is adjusted depending on the local momentum mismatch at different locations along the subject waveguide (and is, therefore substantially non-uniform along such waveguide). This goal is achieved, at least in part, by measuring the thickness of the non-linear crystalline (in a specific example—LN) layer along the waveguide and adjusting the local period of electrodes for domain inversion accordingly. See the schematic of FIG. 2A. As a result, substantially perfect quasi-phase matching condition can be realized across the whole length of the waveguide (compare FIG. 2C with FIG. 2B). Embodiments demonstrate that near-ideal sinc² function second-harmonic spectrum can be recovered with the use of the so-poled waveguide, in contrast to periodic poled devices that show an asymmetric spectrum with multiple peaks. The overall second-order nonlinear efficiency obtained with a LN waveguide device subjected to adaptive profile poling also shows quadratic dependence on the length of the device, which evidences the constructive build-up of the nonlinear process. In particular, the overall second-order nonlinear efficiency of 9415+/−1177%/W was realized in a 21 mm long WG device, which corresponded to about a 8.6-fold improvement over overall efficiency achievable in a comparable conventionally periodically poled WG device. (Notably, for the purposes of the discussion of the idea and the claims, waveguides with aperiodically varying second-order non-linearities in glass materials remain within the scope of the invention, since such waveguides can be used to provide quasi-phase matching, QPM). In waveguides made in non-linear glasses and configured according to the idea of the invention, the QPM would be achieved by corresponding adaptive-non-periodic-formation of alternating regions with non-linearity (poled sections) and regions without non-linearity (unpoled sections)).

For the purposes of this disclosure and the appended claims—and unless expressly defined otherwise—the term higher-order non-linearity is defined as a non-linearity of the second order or an order higher than the second order; the term axial geometric extent of an identified element of feature refers to the geometrical extent of such element of feature along an identified axis (for example, in the case of a waveguide containing material domains aligned along the axis of the waveguide, the axial extent of a domain is the extent of such domain along the axis of the waveguide).

For the purposes of providing a definitive example, the second-harmonic generation was chosen to illustrate the effect of variation of thickness of a layer of LN carrying the waveguide on the overall nonlinear efficiency. For the second-harmonic generation process in a conventionally periodically poled WG device (FIG. 1A), as known in the art, the quasi-phase matching condition is fulfilled when the additional momentum provided by the domain inversion compensates the intrinsic momentum mismatch between fundamental and second-harmonic fields

$$\frac{2 π}{Λ} = \frac{2 ω}{c} ( {n}_{1} - {n}_{2} ) ,$$

with A denoting the poling period, n₁ and n₂ denoting the effective refractive indices for the fundamental and second-harmonic fields respectively. Under the approximation of non-depleted optical field at the fundamental frequency (fundamental harmonic), the overall second-harmonic efficiency can be expressed as

$$η = \frac{{P}_{out}}{{P}_{in}^{2}} = \frac{1}{{n}_{1}^{2} {n}_{2}} \cdot \frac{{A}_{2}}{{A}_{1}^{2}} \cdot \frac{2 {ω}^{2} {d}_{eff}^{2}}{{ε}_{0} {c}^{3}} \cdot {\vert {\int }_{0}^{L} {e}^{i ( \frac{2 {n}_{1} ω}{c} - \frac{2 {n}_{2} ω}{c} - \frac{2 π}{Λ} ) z} dz \vert}^{2} \qquad ( 1 )$$

with P₁=Pᵢₙ representing the pump (fundamental harmonic) power, P₂=Pₒᵤₜ representing the second-harmonic power, ω representing the fundamental field angular frequency, A₁ and A₂ denoting the mode areas of the fundamental and second-harmonic fields respectively, ϵ₀ being the vacuum permittivity, c being the speed of light in vacuum, d_{eff} being the effective nonlinear coefficient considering the full nonlinear susceptibility tensor, and L being the length of the WG device. Notably, Eq. (1) addresses the overall nonlinear efficiency instead of the length-normalized efficiency (which is defined as η/L²).

As a person of ordinary skill will appreciate, assuming spatially-uniform propagation of an optical through the waveguide device, effective refractive indices and mode areas can be considered to remain substantially constant or unchanged along the propagation distance z. Under such an assumption, poling of the waveguide with a constant poling period along the waveguide is sufficient to achieve the goal. In this case, Eq. (1) can be directly integrated to result in the standard sinc²-function shaped spectrum for ideal periodic poling and the second-harmonic power having quadratic dependence on both the pump power and device length L:

$$η = \frac{{P}_{out}}{{P}_{in}^{2}} = \frac{2 {ω}^{2} {d}_{eff}^{2}}{{n}_{1}^{2} {n}_{2} {ε}_{0} {c}^{3}} \cdot \frac{{A}_{2}}{{A}_{1}^{2}} \cdot {L}^{2} \cdot {sinc}^{2} ( \frac{δ kL}{2} ) \qquad ( 2 )$$

$$with δ k = \frac{2 {n}_{1} ω}{c} - \frac{2 {n}_{2} ω}{c} - \frac{2 π}{Λ}$$

denoting the momentum mismatch.

$${P}_{out} = \frac{2 {ω}^{2} {d}_{eff}^{2} {A}_{2}}{{n}_{1}^{2} {n}_{2} {ϵ}_{0} {A}_{1}^{2}} {L}^{2} {P}_{in}^{2} \qquad ( 3 )$$

In practice, however, when optical mode is confined in nanophotonic waveguides, effective refractive index and mode areas can change along the propagation distance due to the non-uniformity of the waveguide geometry. The change of mode areas can be considered as high-order effect, as nonlinear process can still constructively build up if the optical momentum mismatch vanishes along the entire waveguide. Optimum nonlinear efficiency can still be achieved with the effective mode area equal to the average value along the waveguide. On the other hand, the change of effective refractive index can cause the destructive interference of the nonlinear process in different sections of the waveguide. This leads to the drastic drop of the peak nonlinear efficiency, as well as the deviation of the since function for the second-harmonic spectrum. As the thickness variation is random, the nonlinear efficiency and spectrum are highly dependent on the actual waveguide non-uniformity profile. As a result, it is challenging to faithfully reproduce devices with high nonlinear efficiency and fabricate large-size devices.

The second-harmonic power is highly dependent on the inhomogeneous profile of the actual practical waveguide. Our simulation shows the thickness deviation is the major factor influencing the phase matching condition the most (see Supplementary section below for additional details and information). The device layer thickness (the thickness of lithium niobate optical waveguides) can change up to and even over 10 nm on the centimeter scale (FIG. 2E). This understandably can cause the center wavelength shift of the second-harmonic signal over several tens of nanometers (in one case-over 80 nm), which is significantly larger than the second-harmonic bandwidth. As a result, nonlinear efficiency differs across a wide spectrum range thereby leading to low peak efficiency, as well as increasing the deviation from the ideal sinc²-function for the second-harmonic spectrum (FIG. 2F)

The overall nonlinear efficiency only increases quadratically with small device length, when thickness variation (phase mismatch) is not significant relative to the second-harmonic bandwidth (FIG. 2G). Increasing device length cannot improve the overall nonlinear efficiency (curve 250, FIG. 2G) due to the large phase mismatch. Instead of the quadratic dependence on device length, the overall nonlinear efficiency can even decrease as the length of the WG keeps increasing. Therefore, efficient second-order nonlinear processes have only been demonstrated using nanophotonic lithium niobate waveguides with device length below several millimeters.

According to the idea of the invention, to achieve high nonlinear efficiency, the change of optical momentum due to waveguide non-uniformity can be compensated by adjusting the spatial extent of a poling increment (which can be thought of as a local value of a poling period). As a result, the ideal quasi-phase matching condition is maintained for substantially the entire waveguide

$$\frac{2 π}{Λ ( z )} = \frac{2 ω}{c} ( {n}_{1} ( z ) - {n}_{2} ( z ) ) ,$$

even though each of the effective refractive indices (n₁(z) and n₂(z)) and local poling period (Λ(z)) vary along the waveguide. Therefore, the ideal case for the second-harmonic generation expressed according to Eq. (2) can still be achieved. The overall efficiency of this chosen nonlinear optical frequency conversion in this case increases quadratically with the device length, in spite of the geometry variation (curve 260, FIG. 2G). This is in advantageous contradistinction with the situation presence when the used variable thickness waveguide is conventionally, periodically poled and where increasing device length simply does not allow the user to improve the overall efficiency of nonlinear optical conversion due to the large optical momentum mismatch.

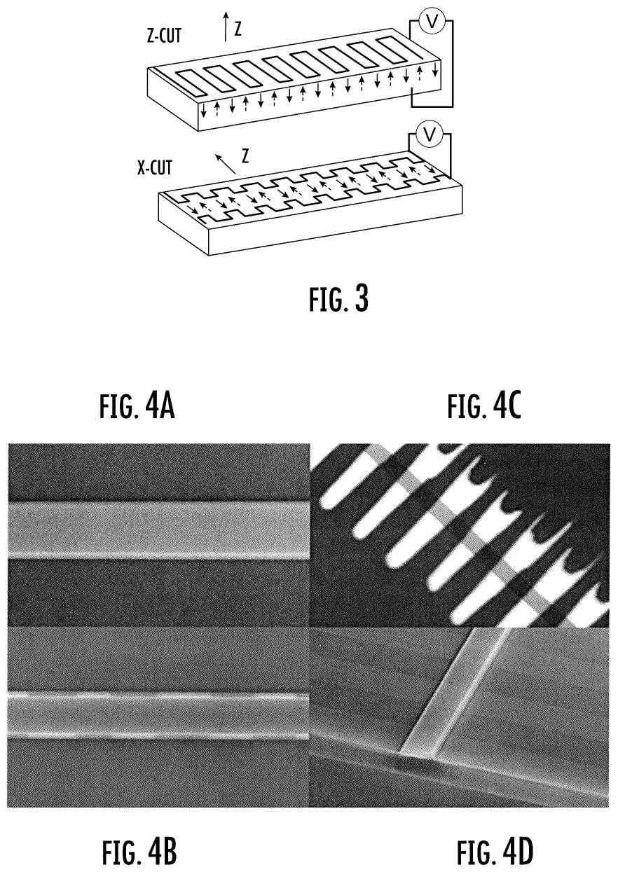

The proposed methodology can be generally applied to lithium niobate wafers with different crystal orientation (FIG. 3). In one non-limiting example, an X-cut lithium niobate wafer was used to fabricate nanophotonic waveguides. Nickel electrodes were first patterned on top of the lithium niobate device layer for domain inversion. Multiple high-voltage pulses were then applied to nickel electrodes at an elevated temperature. After, nickel electrodes were removed—for example, with the use of hydrochloric acid. Standard lithography processing was further used to define the photonic waveguide structure, which was then appropriately poled. The Electron-beam lithography was further used to define the photonic waveguide with hydrogen silsesquioxane resist. The waveguide pattern was then placed into the poling apparatus. The top width of the ridge waveguide was about 1.8 um. The pattern was transferred to the lithium niobate device layer (600 nm thick) using argon-based plasma processing with 350 nm etching depth. The waveguide direction was substantially aligned with the Y axis of the lithium niobate crystal. The fundamental transverse-electric TE₀₀ modes were utilized for both the fundamental field/harmonic around 1550 nm and the second-harmonic field/harmonic around 775 nm (Insets of FIG. 2D). This allowed the largest second-order nonlinear component d₃₃=−19.5 pm/V in lithium niobate to be utilized. The fabricated device is shown in FIG. 4A. The resulting domain inversion in the LN was visualized with the use of piezoresponse force microscopy. As shown in FIGS. 4B, 4C, domain inversion with a near 50% (in this case, 49%+/−4%) duty cycle was achieved.

Several waveguides with identical design parameters were fabricated side by side, one with conventional periodic poling and the rest with various combinations of poling region lengths (adaptive poling) to demonstrate the comparison between the conventional and the proposed poling approaches.

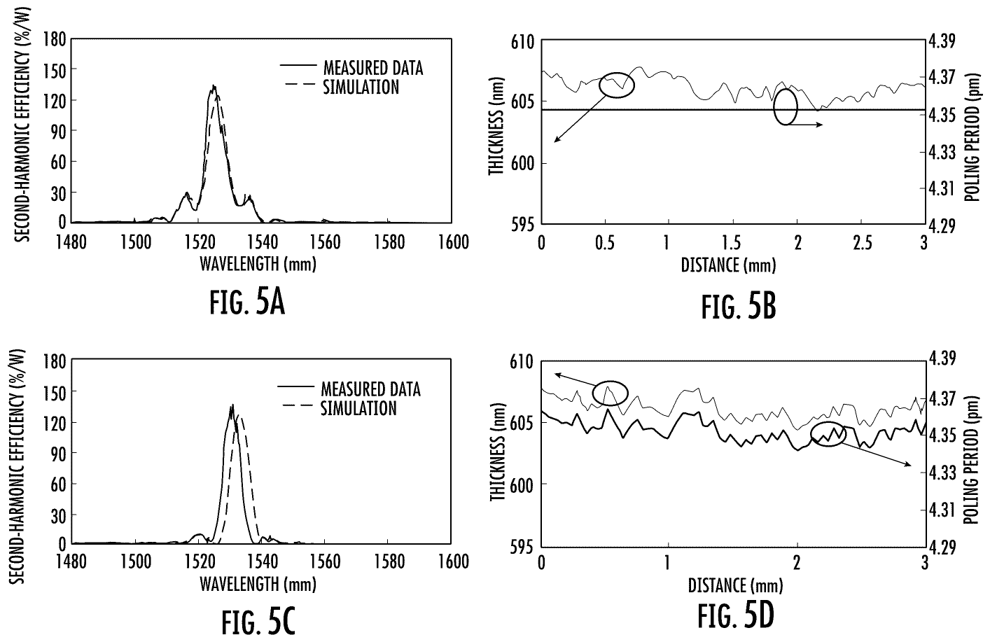

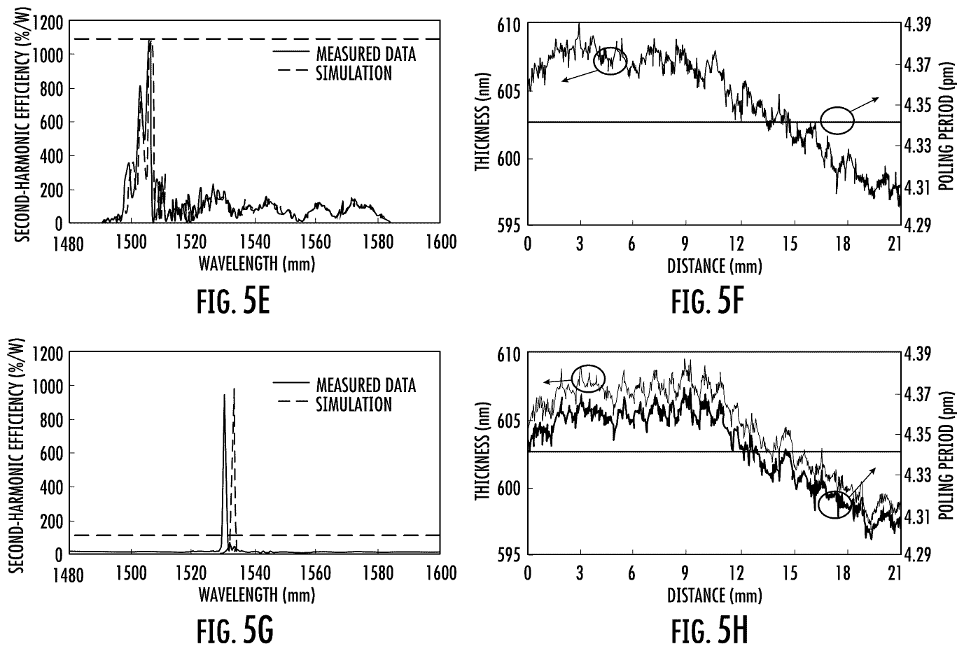

First, the nanophotonic lithium niobate waveguide with standard/conventional periodic poling was tested. The thickness measured along such waveguide is presented in FIG. 5B for 3 mm long WG and in FIG. 5F for a 21 mm long WG. The poling period was about 4.35 microns as determined by the average thickness of the WG device. Light was launched into and collected from the WG with a pair of lensed optical fibers. A continuous-wave tunable laser source was used as the pump. The polarization was controlled by an in-line fiber-based polarization controller. Transmitted through the WG fundamental and second-harmonic fields were separated with a fiber wavelength-division multiplexer, and detected with InGaAs and Si PIN photodetectors, respectively. When the wavelength of used light was tuned into the phase matching bandwidth, strong second-harmonic light could be observed.

For a 3 mm long WG device (since the bandwidth of the spectrum remain substantially wide), no significant broadening and peak efficiency compromising was observed (see FIG. 3A). When the 21 mm long WG device was used, on the other hand, due to the large thickness variation of the WG along this length, the output second-harmonic signal displayed an asymmetric spectrum (FIG. 3E), thereby proving that different sections or portions of such WG required different phase-matching wavelengths for optimal operation. The maximum second-harmonic efficiency was measured as 1092%/W for the 21 mm long device (which value was significantly lower than the theoretical limit of 10530%/W).

Afterwards, to evaluate the embodiment prepared according to the idea of the invention, the nanophotonic lithium niobate waveguide fabricated with the use of an embodiment of adaptive profile poling was tested. The thickness was measured with the use of Filmetrics F40 with material spatial resolution of 10 mm. The local poling period (that is, the target extent of poling increment as a function of the length of the waveguide) was calculated point by point based on the Finite element simulation Solutions simulated relation between the quasi-phase matching condition and waveguide thickness as shown in FIG. 2D. The resulted pattern of the local poling period is shown in FIG. 5B for a 3 mm long device and in FIG. 5H for a 21 mm long device. The second-harmonic spectrum was measured using the same setup. Near-ideal second-harmonic spectrum represented by a substantially symmetric sinc²-function could be clearly observed (FIGS. 5C, 5G). The peak second-harmonic efficiency was significantly higher (as high as 9415+-1177%/W) has been measured with 21-mm-long device, which corresponded to a 8.6-fold improvement in comparison with that obtained in a conventionally-poled waveguide device. The results demonstrated that the variation of thickness of a waveguide device can be and is in practice compensated with the use of the adaptive profile poling procedure, implemented according to the idea of the invention, and that substantially ideal quasi-phase matching condition can and is in practice realized across the entire length of the waveguide made in a nonlinear material.

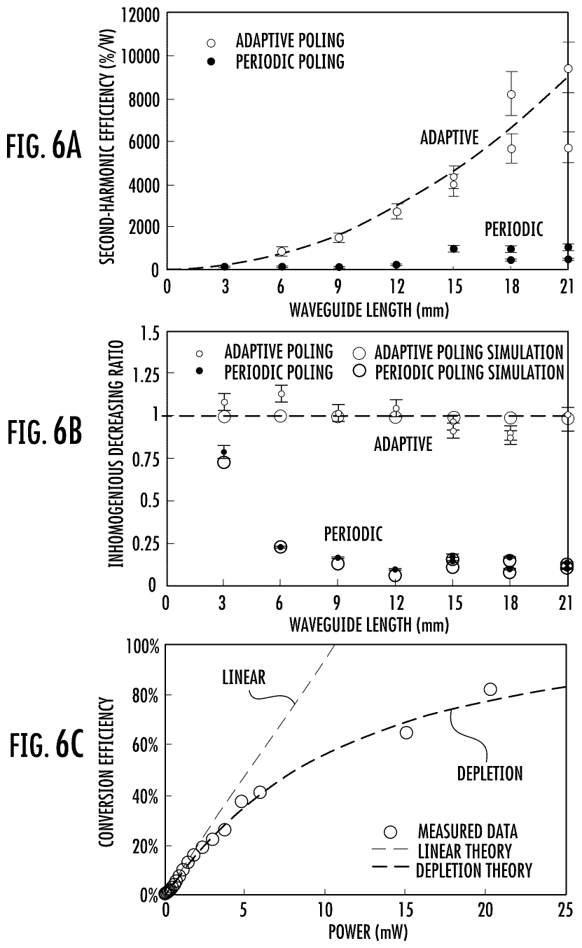

To further illustrate the operational advantage of the proposed methodology of adaptive poling, additional testing was performed of nonlinear nanophotonic lithium niobate waveguides having different lengths and poled either conventionally periodically or adaptively (and, therefore, aperiodically or even irregularly—that is, in a way that is not even or balanced in shape or arrangement-according to the proposed methodology. The peak value of second-harmonic generation efficiency was shown to scale substantially quadratically with the device length for the adaptively poled waveguides, matching the theoretical prediction in the case of ideal quasi-phase matching (FIG. 6A). Since any additional and/or unexpected loss in each waveguide likely causes the error in the second-harmonic efficiency measurement, as so does the extent of waveguide inhomogeneities, comparison between or among different waveguides was not a trivial undertaking. To facilitate such a comparison, a figure of merit Rᵢₙₕₒₘₒ (referred to herein as the inhomogeneity-based SHG decreasing ratio) was introduced to account for various waveguide inhomogeneities that cause the decrease of second-harmonic generation efficiency:

$${R}_{inhomo} = {η}_{pk , inhomo} / {η}_{pk , homo} \qquad ( 4 )$$

Here Rᵢₙₕₒₘₒ represents the measured peak of SHG efficiency, η_{pk,inhomo} represents the measured peak of SHG efficiency with certain non-zero degree of broadening of the SHG spectrum caused by the present WG inhomogeneities, whereas η_{pk,homo} represents the peak of SHG efficiency assuming no inhomogeneities of the WG device are present. Rᵢₙₕₒₘₒ is substantially independent from the SHG efficiency and/or any loss of light in the waveguide, and can be revealed from the ratio of the peak value to the area of SHG efficiency spectrum (see Supplementary section below). As shown in FIG. 6B, displaying the dependence of Rᵢₙₕₒₘₒ on the length of a waveguide, the data point representing the results obtained with the adaptively poled waveguides are substantially aligned with the line of Rᵢₙₕₒₘₒ=1, thereby convincingly demonstrating that the adaptive poling of the waveguides substantially perfectly addresses or solves the issue of decrease of non-linear conversion efficiency caused by various inhomogeneities of a waveguide (including variations of the waveguide thickness along the waveguide axis, variations of waveguide width, deviations of the dimensions of the poled domains from those intended, deviations of the etch depth, to name just a few) issue. In particular, the 21 mm long adaptively poled waveguide experimentally demonstrated Rᵢₙₕₒₘₒ=0.958, which meant that detrimental contribution of various inhomogeneities of such waveguides into decrease of the SHG efficiency was substantially completely compensated by the aperiodic poling. As compared to the theoretical limit 10530%/W, an additional factor of 0.93 was assessed to have come primarily from the imperfection and uncertainty of the formed adaptive aperiodic poling profile.

In contrast, lithium niobate waveguides with conventional periodic poling did not show any consistent second-harmonic spectrum regardless of the waveguide length, as the waveguide thickness profiles were uncorrelated among different such waveguides. The use of a longer waveguide in this case simply cannot (and did not, in practice) help to improve the overall efficiency of a nonlinear frequency conversion either, as phase mismatch beyond it necessarily caused the suppression of the second-harmonic signal.

Finally, 21 mm long adaptively poled waveguides were examined in the power depletion region, and measurements of the absolute power conversion efficiency were performed. Here, the same measurement setup as mentioned above was used except the last two data points (see the right side of the “depletion” curve of FIG. 6C) were measured with an in-line erbium-doped fiber amplifier after the tunable 1550 nm laser. Here, the highest value of the measured SHG power was 16.8 mW with a pump power of 20.3 mW, corresponding to about 82.6% of power conversion efficiency. The data points were using the pump-depletion model (discussed in any standard textbook on nonlinear optics) resulting in the fitted SHG efficiency of 9550+-490%/W, which range was consistent with the previous value(s) measured in the linear region.

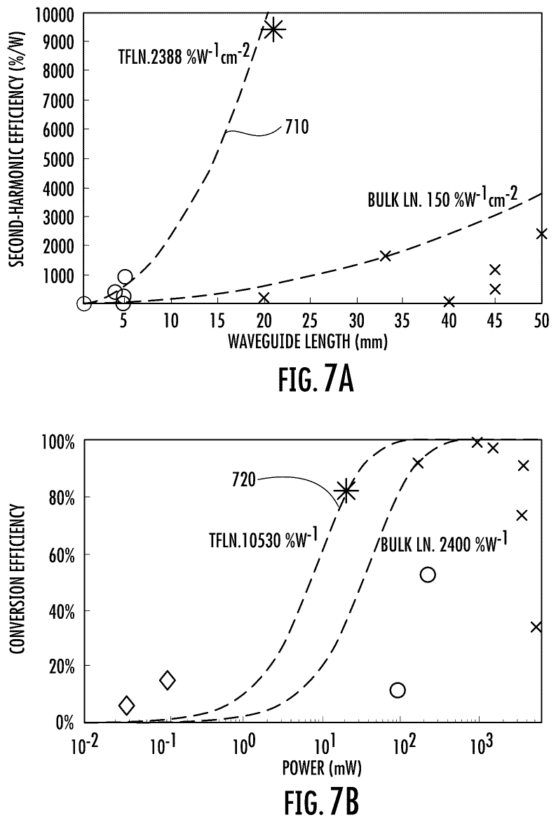

To benchmark the performance and operational advantages of the proposed adaptive poling methodology, FIGS. 7A, 7B present the comparison(s) of the performances of various lithium niobate waveguide devices employing second-order nonlinear processes. As seen in FIG. 7A (curve 710), the poled waveguides prepared according to the idea of the invention demonstrated a 4-fold improvement as compared with the highest overall non-linear conversion efficiency achieved in related art. As shown in FIG. 7B, the poled waveguides prepared according to the idea of the invention demonstrated the power conversion efficiency of above 80% with the lowest pump power required.

It is appreciated that the above demonstration of the implementation of the idea of the invention in X-cut LN was used only as an example, and that embodiments of the invention can be implemented, generally, in substantially any nonlinear crystalline material (that is subjected to poling to realize a waveguide-based nonlinear device, such as KDP, Lithium Tantalate, or Z-cut lithium niobate, to name just a few) or, for that matter, in a glass-material (in which waveguides with varying second-order non-linearities are formed to provide quasi-phase matching due to the presence of axially aperiodically alternating regions with non-linearity, poled sections of the waveguide, and regions without non-linearity, unpoled sections). The implementation of an embodiment of the invention can be applied to compensate other sources of waveguide spatial non-uniformity such as etching depth, dose of exposure to light used for lithographic patterning (affecting at least the width of the waveguide), and distribution of doping density across the chips or substrate or wafer of a chosen nonlinear material (affecting at least an index of refraction of a particular waveguide mode).

### Supplementary

### 1) Assessment of the Inhomogeneity-Based SHG Decreasing Ratio.

A person of ordinary skill readily appreciates that the aperiodically poled waveguide device configured according to the idea of the invention is operated in the linear regime of nonlinear frequency conversion, without depleting pump power. In reference to Eq. (4) above, and considering a length of the poled WG device that is so short that it includes only a few poled domains and inhomogeneities (including those associated with non-uniformities in the WG thickness), the measured normalized SHG efficiency of such short device can be defined as intrinsic normalized SHG efficiency, η_{pk,norm,i}, and η_{pk,homo} is equal to η_{pk,norm,i}L², where L is the length of a poled domain/region.

The area under the curve representing the SHG power spectrum with respect to the pump wavelength is (see J. Opt. Soc. Am. B 10, 222-229 (1993), incorporated by reference herein)

$${A}_{{p}_{2}} = \int {P}_{2} ( {λ}_{1} ) d {λ}_{1} = \frac{2 π}{L} {( \frac{d Δ k}{d {λ}_{1}} )}^{- 1} {P}_{2 , pk , homo} = α {P}_{2 , pk , homo} {L}^{- 1} \\ α = 2 {π ( \frac{d Δ k}{d {λ}_{1}} )}^{- 1}$$

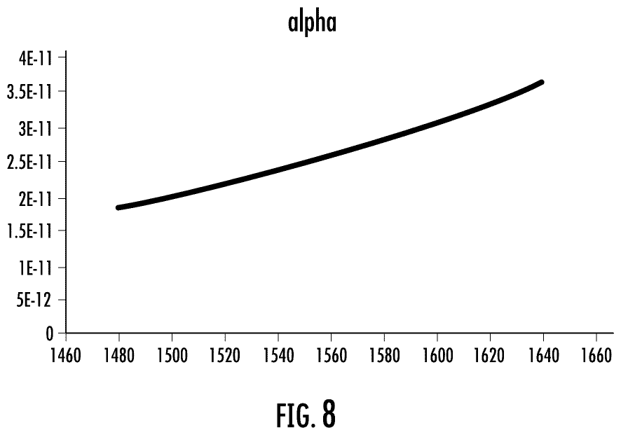

Here, Δₖ is phase mismatch, λ is a wavelength of light, subscript of 1 means refers to the fundamental field while subscript of 2 identifies the second-harmonic field. The value of a can be calculated with the simulation of Finite element simulation solutions, and the resulting curve showing a as a function of wavelength of light is presented in FIG. 8.

The value of Rᵢₙₕₒₘₒ can be assessed as follows, for example:

a. Only using the result of Finite element simulation solutions.

Since the SHG spectrum procured with the use of adaptively poled devices extends across a somewhat short spectral range, a can be viewed as a substantially constant parameter. Also, A_{P2} is substantially independent to the inhomogeneous broadening (see J. Opt. Soc. Am. B 10, 222-229 (1993), Appendix A). That is

$${A}_{{p}_{2}} = {A}_{{p}_{2} , inhomo} = {A}_{{p}_{2} , homo}$$

Normalizing the above by the square of fundamental (pump) power, one can obtain

$${A}_{η} = {A}_{η , inhomo} = {A}_{η , homo}$$

From the experiment (with the use of a fundamental wavelength of 1550 nm and a second harmonic wavelength of 775 nm), the output pump power and the variation of the SHG power with respect to the pump wavelength can be procured. By y calibrating the loss figure, one can procure η_{pk,inhomo} and Δ_{η}. Then:

$$\frac{{η}_{pk , inhomo}}{{A}_{η} L} = \frac{\frac{{P}_{775 , pk}}{{P}_{1550}^{2}}}{\frac{α {P}_{775 pm}}{{P}_{1550}^{2}}} = \frac{\frac{{P}_{775 , pk}}{{P}_{1550}^{2}}}{\frac{α {P}_{775 pm}}{{R}_{inhomo} {P}_{1550}^{2}}} = {R}_{inhomo} {α}^{- 1}$$

(the numerical subscripts refer to chosen wavelengths of fundamental and second harmonics, in nanometers).

If the loss is not calibrated,

$$\frac{{η}_{pk , inhomo}}{{A}_{η} L} = \frac{\frac{{P}_{775 , pk , loss}}{{P}_{1550 , loss}^{2}}}{\frac{α {P}_{775 pm , loss}}{{P}_{1550 , loss}^{2}}} = \frac{\frac{{P}_{775 , pk} {T}_{775}}{{P}_{1550}^{2} {T}_{1550}^{2}}}{\frac{α {P}_{775 pm} {T}_{775}}{{P}_{1550}^{2} {T}_{1550}^{2}}} = {R}_{inhomo} {α}^{- 1}$$

Here, parameter Tᵢ represents the transmission due to any loss. The above ratio is independent from the SHG efficiency and loss figure, and only depends on Rᵢₙₕₒₘₒ. Therefore, Rᵢₙₕₒₘₒ has comparable values for different waveguides no matter what the loss and intrinsic SHG normalized efficiency of a given waveguide. Additionally, the values of Rᵢₙₕₒₘₒ obtained in experiment and dues to simulation are comparable as well.

On the other hand, the ratio of η_{pk,inhomo}/(RᵢₙₕₒₘₒL²) can be calculated to remove the factor of inhomogeneity, and this ratio number only depends on η_{norm,i} and loss. Since all of the different waveguide devices were fabricated together, η_{norm,i} and loss factor characterizing such waveguide should not differ too much from one another. Upon the statistical inspection of data, the outliers (waveguides exhibiting significant additional loss causing a large error of the measured SHG efficiency) could be removed accordingly. Then we can remove these data points accordingly.

b. Using the result of inhomogeneity simulations.

In this case, since the SHG spectrum of poled devices spans a wide spectral range, the assumption of the constant value of a is not applicable. However, since the spectra of simulation and experiment agree well, one can compare both by setting A_{η} to be the same. Moreover, one can obtain the Rᵢₙₕₒₘₒ from simulation result, and infer the Rᵢₙₕₒₘₒ of the experimental data of periodically poled devices with the help of simulation. In FIG. 3, all data points are plotted using this way.

### 1) Additional Considerations for Various SHG Efficiency Related Parameters

a. SHG Efficiency of Selected Waveguide

| Poling | | | Measured normalized | Intrinsic normalized | Total SHG | |
|---|---|---|---|---|---|---|
| approach | length | | SHG efficiency | SHG efficiency | efficiency | Rᵢₙₕₒₘₒ |
| Periodic poling | 3 | mm | 1503%/W-cm\hat{ }2 | 1916%/W-cm\hat{ }2 | 135.3%/W | 0.784 |
| Adaptive poling | 3 | mm | 1534%/W-cm\hat{ }2 | 1418%/W-cm\hat{ }2 | 138.1%/W | 1.08 |
| Periodic poling | 21 | mm | 247.5%/W-cm\hat{ }2 | 2441%/W-cm\hat{ }2 | 1092%/W | 0.101 |
| Adaptive poling | 21 | mm | 2135%/W-cm\hat{ }2 | 2229%/W-cm\hat{ }2 | 9415%/W | 0.958 |

Note:
The fact that the value of Rᵢₙₕₒₘₒ for an adaptively poled 3 mm long device was obtained to be larger than 1 is explained by some unexpected modulation of the SHG spectrum occurring down stream, after the SH was generated.

b. Dimensional Sensitivity.

The phase matching condition is understandably very sensitive to the waveguide geometry. In this work, the Finite element simulation solutions were used to simulate and show the sensitivity of fundamental wavelength of the phase match peak shift as a function of the deviation of different dimensional parameters of the poled waveguides:

TABLE 1

| | | |
|---|---|---|
| Δ fundamental wavelength of phase match peak | 10 | nm |
| Δ Thickness | −1.34 | nm |
| Δ Poling period | 7.66 | nm |
| Δ Waveguide width | −16.7 | nm |
| Δ Etch depth | 18.6 | nm |

Note for Table 1:
The nominal waveguide parameters we: thickness 600 nm, extent of the poled domain 4.315 μm, waveguide width 1.8 μm, and etch depth 350 nm.

From the above-presented Table 1, the phase matching condition is expected to remain most sensitive to the thickness variation. Accordingly, the proposed adaptive poling methodology is primarily addressing the thickness variation. The phase matching condition should remain substantially robust with respect to the geometrical extent of the poled domain, the latter being defined by the electrode pattern design and mostly fabrication error-free. There might be overall scaling due to the EBL inaccurate length calibration, but this would only make the whole spectrum shift without introducing inhomogeneity.

The deviations of the waveguide width primarily caused by the process of distortion of the electron beam lithography (when such process is used for fabrication of the waveguide), writing current drifting, and waveguide etching quality, wet etching, and BOE (buffered oxide etching). In terms of EBL field distortion, it may be practically sufficient to eliminate low spatial frequency deviation by fixing the relative position of the waveguide pattern in the writing field. Writing current drifting and waveguide etching quality are not expected to be substantial erroneous if the corresponding tools are in good condition. From the conducted experiments, 1% EBL current drift was equivalent to about 2.5 nm deviation in the waveguide width. Writing current drifting is the most critical parameter here, since the drift in the writing current often causes the lowest spatial frequency deviation. Wet etching and BOE etching ideally etch the waveguide homogeneously, which only causes the whole spectrum to shift without introducing inhomogeneity.

Deviations of the etch depth are understandably dependent on the etching tool, and was found to be related to the temperature gradient across the waveguide chip during the dry etching process. Additional errors were found to include the uncertainty of the waveguide thickness measurement, the uncertainty of thickness measurement position, and the uncertainty of defining the center and width of the poled domain. Here, the accuracy of the thickness measurement was 2.4 nm, the precision was about 0.1 nm (which was understood to substantially not affect the inhomogeneity of the waveguide device). The thickness measurement position uncertainty was about around 10 microns (which was construed to relate to the high spatial frequency deviation and to have only very minor effects), the poling domain center uncertainty was construed to relate to a very high spatial frequency deviation, which has a minor effect on the waveguide inhomogeneity, while the poling domain width uncertainty was found to have substantially no contribution to Rᵢₙₕₒₘₒ (but only to a decrease of the intrinsic normalized SHG efficiency η_{norm,i}).

References throughout this specification to “one embodiment,” “an embodiment,” “a related embodiment,” or similar language mean that a particular feature, structure, or characteristic described in connection with the referred to “embodiment” is included in at least one embodiment of the present invention. Thus, appearances of the phrases “in one embodiment,” “in an embodiment,” and similar language throughout this specification may, but do not necessarily, all refer to the same embodiment. It is to be understood that no portion of disclosure, taken on its own and in possible connection with a figure, is intended to provide a complete description of all features of the invention.

Within this specification, embodiments have been described in a way that enables a clear and concise specification to bet written, but it is intended and will be appreciated that embodiments may be variously combined or separated without parting from the scope of the invention. In particular, it will be appreciated that all features described herein at applicable to all aspects of the invention.

For the purposes of this disclosure and the appended claims, the use of the terms “substantially”. “approximately”, “about” and similar terms in reference to a descriptor of a value, element, property or characteristic at hand is intended to emphasize that the value, element, property, or characteristic referred to, while not necessarily being exactly as stated, would nevertheless be considered, for practical purposes, as stated by a person of skill in the art. These terms, as applied to a specified characteristic or quality descriptor means “mostly”. “mainly”, “considerably”, “by and large”, “essentially”, “to great or significant extent”. “largely but not necessarily wholly the same” such as to reasonably denote language of approximation and describe the specified characteristic or descriptor so that its scope would be understood by a person of ordinary skill in the art. In one specific case, the terms “approximately”, “substantially”, and “about”, when used in reference to a numerical value, represent a range of plus or minus 20% with respect to the specified value, more preferably plus or minus 10%, even more preferably plus or minus 5%, most preferably plus or minus 2% with respect to the specified value. As a non-limiting example, two values being “substantially equal” to one another implies that the difference between the two values may be within the range of +/−20% of the value itself, preferably within the +/−10% range of the value itself, more preferably within the range of +/−5% of the value itself, and even more preferably within the range of +/−2% or less of the value itself.

The use of these terms in describing a chosen characteristic or concept neither implies nor provides any basis for indefiniteness and for adding a numerical limitation to the specified characteristic or descriptor. As understood by a skilled artisan, the practical deviation of the exact value or characteristic of such value, element, or property from that stated falls and may vary within a numerical range defined by an experimental measurement error that is typical when using a measurement method accepted in the art for such purposes.

The term “and/or”, as used in connection with a recitation involving an element A and an element B, is defined to have the same meaning as “one of at least A and B”. The term “identified preferred materials” refers to and/or is defined as and/or includes the following materials known in related art: KTP, beta-BBO, LBO, CLBO, DKDP. ADP, KDP, LiIO₃, KNbO₃, LiNbO₃, AgGaS₂, AgGaSe₂. The term “identified preferred nonlinear processes” refers to and/or is defined as and/or includes at least the following: processes of harmonic frequency generation, second harmonic generation, third harmonic generation, fourth harmonic generation, fifth harmonic generation, sum frequency generation, and parametric down conversion.

While the invention is described through the above-described exemplary embodiments, it will be understood by those of ordinary skill in the art that modifications to, and variations of, the illustrated embodiments may be made without departing from the inventive concepts disclosed herein. For example, the proposed adaptive poling methodology can also be applied to compensate various other inhomogeneities of fabrication of a WG device, for example, non-uniformities in etching depth, depth of diffusion of dopants into the material substrate carrying the WG, non-uniformities in the dose of lithographic exposure of such substrate, and those in doping density of the predetermined material across the substrate, to name just a few.

A skilled person will also readily appreciate that the scope of the invention includes photonic devices that are configured to incorporate an optical waveguide structured according to the idea of the invention and/or an optical component that carries such optical waveguides. Such photonic devices include—but are not limited to—frequency doublers, parametric gain amplifiers, frequency converters, optical parametric oscillators, optical parametric amplifiers, phase-sensitive amplifiers, phase-insensitive amplifiers, single photon source, squeezers, isolators, and devices configured to effectuate a supercontinuum generation as known in the art. Embodiments of the invention additionally provide a method for fabricating an optical waveguide having an axis by poling a birefringent substrate configured to carry the optical waveguide aperiodically along the axis to form poled regions of the waveguide such that an axial geometrical extent of each of the poled regions of the waveguide are necessarily dependent on at least values of thickness of said waveguide at axial locations of the poled regions. In one case, the poling process is complemented with a process of determining a non-uniformity of the thickness of the waveguide along the axis to define a distribution of axial geometrical extents of the poled regions as a function of a length of the waveguide, and/or may include poling the material of the substrate such that the axial geometrical extent of a given poled region is dependent at least in part on a value of a width of the waveguide and/or a value of an index of refraction of the waveguide at a location of the given poled region. In the latter case, the poling step may be additionally complemented with a step of determining a non-uniformity of the non-uniformity of the width and/or the index of refraction of the waveguide along a length of the waveguide to define a distribution of a longitudinal extent of a target inversion of a poled domains of the material substrate as a function of the length. The fabrication of the optical waveguide may include forming the waveguide (for example, using lithographic procedures and/or diffusion process) includes a crystalline material or a glass material, in the material substrate. (When the waveguide includes the glass material, the different poled region of the waveguide may include axially-alternating first region with non-zero non-linearity and second region without non-linearity.)

Disclosed aspects, or portions of these aspects, may be combined in ways not listed above. Accordingly, the invention should not be viewed as being limited to the disclosed embodiment(s).

What is claimed is:

1. An optical component comprising:
a substrate made of a material, the substrate having an axis and an axial profile of a non-linearity parameter, said axial profile being not periodic,
wherein said axial profile is formed by poled domains of said material, and
wherein different poled domains of said material necessarily have different from one another axial geometric extents.

2. An optical component according to claim 1, wherein:
(2A) the axial geometric extents of said different poled domains are dependent on inhomogeneous distribution of at least one of material parameter and/or at least one geometric parameter of said material substrate along the axis;
and/or
(2B) the material includes at least one of identified preferred materials, and the different poled domains include a first ferroelectric domain that has a first axial geometrical extent along the axis, a second ferroelectric domain has a second geometrical extent along the axis, and a third ferroelectric domain has a third geometrical extent along the axis, and wherein each of the first, second, and third geometrical extents is different from the other two of the first, second, and third geometrical extents.

3. An optical component according to claim 2, containing an optical waveguide formed in said substrate, the optical waveguide having said axis and comprising, along a length thereof, said axial profile of non-linearity parameter of the material and said different poled domains.

4. An optical component according to claim 3, wherein:
the axial geometric extents of said different poled domains of the waveguide are dependent at least on corresponding different values of a thickness of the waveguide at locations of said different poled domains.

5. An optical component according to claim 1, containing an optical waveguide formed in said non-linear material substrate, the waveguide having said axis and comprising, along a length thereof, said axial profile of non-linearity parameter of the material and said different poled domains,
wherein the substrate includes a birefringent material and wherein said poled domains are spaced substantially irregularly along the axis and represent said birefringent material poled substantially aperiodically along the axis.

6. An optical component according to claim 2, wherein the axial extents of said different domains are configured to substantially satisfy a quasi-phase matching condition for a predefined process of nonlinear conversion of optical energy substantially at every chosen point of said axis.

7. An optical component according to claim 3, wherein the axial extents of said different domains are configured to substantially satisfy a quasi-phase matching condition for a predefined process of nonlinear conversion of optical energy substantially at every chosen location and/or every chosen region of said optical waveguide.

8. An optical component according to claim 5, wherein the axial extents of said different poled domains are configured to substantially satisfy a quasi-phase matching condition for a predefined process of nonlinear conversion of optical energy substantially at every chosen location and/or every chosen region of said optical waveguide.

9. An optical component according to claim 6, wherein the predefined process of nonlinear conversion includes one of identified preferred nonlinear processes.

10. An optical component according to claim 7, wherein the predefined process of nonlinear conversion includes one of identified preferred nonlinear processes.

11. An optical component according to claim 9, wherein the predefined process of nonlinear conversion includes one of identified preferred nonlinear processes.

12. A method according to claim 1, the method comprising:
poling said substrate substantially aperiodically along the axis, wherein the substrate has an inhomogeneous axial distribution of at least one of material parameter and/or at least one geometric parameter,
wherein an axial geometrical extent of a given poled region of the substrate is necessarily dependent on a value of said at least one material and/or at least one geometric parameter of said material substrate at a location of such poled region along the axis.

13. A method according to claim 12, wherein the poling includes poling said substrate containing at least one of identified preferred materials to form said different poled domains,
wherein said different poled domains include a first ferroelectric domain that has a first axial geometrical extent along the axis, a second ferroelectric domain that has a second geometrical extent along the axis, and a third ferroelectric domain that has a third geometrical extent along the axis such that each of the first, second, and third geometrical extents is different from the other two of the first, second, and third geometrical extents,
wherein a corresponding axial geometrical extent of each of the different poled domains is necessarily dependent on a value of the at least one material parameter and/or a least one geometric parameter of said substrate at a location of such each of the different poled domains along the axis.

14. A method according to claim 12,
wherein the optical component contains an optical waveguide formed in said substrate,
wherein the optical waveguide has said axis and comprises, along a length thereof, said axial profile of non-linearity parameter of the material,
wherein regions of the optical waveguide are poled regions defined by said different poled domains,
wherein the method comprises determining a non-uniformity of a thickness of said optical waveguide along the axis to define a distribution of a longitudinal extents of a target poled domain of said material substrate as a function of a length of the waveguide.

15. A method according to claim 14, wherein said poling includes poling the material of the substrate such that the axial geometrical extent of a given poled region of the optical waveguide is dependent at least in part on a value of a width of said optical waveguide and/or on a value of an index of refraction of said optical waveguide at a location of the given poled region.

16. A method according to claim 15, further comprising determining a non-uniformity of the thickness of said optical waveguide along the axis and/or a non-uniformity of the width of said optical waveguide and/or a non-uniformity of the index of refraction of said optical waveguide along the length thereof to define a distribution of a longitudinal extent of a target inversion of a poled domain of said material substrate as a function of the length.

17. A method according to claim 12, comprising:
forming an optical waveguide in said substrate, and
wherein said poling includes poling the material of the substrate carrying the optical waveguide at least aperiodically along the axis such that an axial geometrical extent of a given poled region of the optical waveguide is necessarily dependent on at least one of a value of a thickness of said optical waveguide, a value of a width of said optical waveguide, and a value of an effective index of refraction of said optical waveguide at a target wavelength at a location of said given poled region,
wherein the target wavelength is associated with a target process of nonlinear optical frequency conversion in said optical waveguide.

18. A method according to claim 17, wherein the forming includes forming an optical waveguide in said substrate including a crystalline material or a glass material.
